(19) United States
(12) Patent Application Publication
(10) Pub. No.: US 2010/0245465 A1
(43) Pub. Date: Sep. 30, 2010

(54) LIQUID SUPPLYING APPARATUS AND LIQUID EJECTING APPARATUS

(75) Inventors: Chikashi NAKAMURA, Hata-machi (JP); Seiya SATO, Matsumoto-shi (JP)

Correspondence Address: Workman Nydegger;1000 Eagle Gate Tower, 60 East South Temple, Salt Lake City, UT, 84111, US

(73) Assignee: Seiko Epson Corporation, Tokyo (JP)

(21) Appl. No.: 12/729,508

(22) Filed: Mar. 23, 2010

(30) Foreign Application Priority Data
Mar. 26, 2009 (JP) 2009-077504

(51) Int. Cl. B41J 2/165

(52) U.S. Cl. 347/30

(57) ABSTRACT

A liquid ejecting apparatus includes a liquid ejecting head and a cleaning device. The liquid ejecting head has a nozzle formation surface and nozzles formed therethrough. The cleaning device applies a suction force to the inside of the liquid ejecting head through the nozzles to suck the liquid out of the liquid ejecting head for forcible discharging of the liquid. A liquid supplying apparatus includes a liquid supplying passage through which the liquid is supplied from a liquid supplying source at an upstream side, toward the liquid ejecting head at a downstream side. A pump is driven for suction and discharging operations. The pump includes a pump chamber and a displacement member. The displacement member is displaced between two or more positions that include a close position for closing an outlet port through which the liquid flows out of the pump chamber to the downstream side.

This application claims the benefit of Japanese Patent Application No. 2009-077504, filed Mar. 26, 2009, which is expressly incorporated herein by reference in its entirety.

### BACKGROUND

1. Technical Field

The present invention relates to a liquid supplying apparatus and a liquid ejecting apparatus.

2. Related Art

An ink-jet recording apparatus (hereinafter referred to as “printer”) is widely known as an example of a liquid ejecting apparatus that ejects liquid from a liquid ejecting head onto a target medium. In the operation of such a printer, there is a risk of poor printing that is caused by the clogging of nozzles that occurs because of an increase in the viscosity of ink, or solidification thereof, due to the evaporation of ink solvent through the nozzles of a recording head, which is an example of a liquid ejecting head, or because of the adhesion of dust thereto. Air bubbles that are formed inside the recording head due to the entering of air through the nozzles sometimes cause poor printing.

In order to overcome the problem of poor printing that is caused by the clogging of nozzles, the formation of air bubbles, or due to other reasons, a printer of the related art can perform so-called choke cleaning for forcibly discharging ink that has increased viscosity or solidified and/or air bubbles out of a recording head due to a suction force by means of negative pressure. An example of such a printer is disclosed in JP-A-2006-198845. Specifically, in choke cleaning, as a first step, a cap member is brought into contact with the nozzle formation surface of a recording head so as to enclose nozzles. Then, a suction pump is driven in a state in which a choke valve is closed. The choke valve is provided somewhere on an ink flow passage through which ink is supplied from an ink cartridge to the recording head. The ink flow passage is an example of a liquid supplying passage. The ink cartridge is an example of a liquid supplying source.

When the suction pump is driven in such a choked state, negative pressure is generated inside the cap member. Because of the negative pressure, the inside of the recording head is sucked through the nozzles from the nozzle-formation-surface side. Then, at a point in time at which the negative pressure of a relatively downstream side with respect to (which is downstream as viewed from) the choke valve (i.e., the recording-head side) has reached a sufficiently high level, the choke valve is opened. Since the choke valve is opened, ink flows from a relatively upstream side with respect to the choke valve (i.e., the ink-cartridge side) rapidly with a great force into the recording head. Therefore, ink having increased viscosity and/or air bubbles trapped in the recording head is/are forcibly discharged out of the recording head through the nozzles.

As a method that is used by printers of late for supplying ink from the ink-cartridge side to the recording-head side by means of a pump, a pulsating pumping method is known in the art. A pump that is provided somewhere on an ink flow passage repeats suction operation and discharging operation to supply ink from the upstream side toward the downstream side with short quick operations. An example of such a pulsating pump scheme is disclosed in JP-A-2006-272661. The disclosed printer, which uses the pulsating pump scheme to supply ink, also performs choke cleaning in order to overcome the problem of poor printing that is caused by the clogging of nozzles, the formation of air bubbles, or due to other reasons.

When such a printer that uses the pulsating pump scheme to supply ink performs choke cleaning, the discharging pressure of a pump acts on a choke valve from the upstream side. As a result of the application of the discharging pressure from the upstream side thereto, the choke valve transitions from a valve-closed state into a valve-open state. Since the choke valve opens, ink flows from the upstream side through the choke valve toward the downstream side rapidly with a great force.

However, when ink flows from the upstream side toward the downstream side as a result of the opening of the choke valve, pressure at the upstream side with respect to the choke valve, which was raised due to the discharging pressure of the pump, decreases. For this reason, the choke valve closes again due to negative pressure applied from the downstream side. That is, since the opening and closing of the choke valve is repeated with vibration until the magnitude of a force for opening the choke valve due to discharging pressure applied from the upstream side eventually exceeds the magnitude of a force for closing the choke valve due to negative pressure applied from the downstream side in a stable manner, it is not possible to perform choke cleaning in one burst, which is a problem that remains to be solved.

In addition, since a pulsating pump requires a separate independent space for a choke valve, there is another problem in that it is not possible to reduce cost and the size of an apparatus.

### SUMMARY

An advantage of some aspects of the invention is to provide a liquid supplying apparatus that makes it possible to perform choke cleaning quickly, and in addition, makes the size of an apparatus smaller with a reduction in cost. In addition, the invention provides, as an advantage of some aspects thereof, a liquid ejecting apparatus that is provided with such a liquid supplying apparatus.

In order to address the above-identified problems without any limitation thereto, a liquid supplying apparatus according to a first aspect of the invention has the following features. The liquid supplying apparatus is provided in a liquid ejecting apparatus. The liquid ejecting apparatus includes a liquid ejecting head and a cleaning device. The liquid ejecting head has a nozzle formation surface and a plurality of nozzles formed through the nozzle formation surface. The liquid ejecting apparatus ejects liquid through the nozzles of the liquid ejecting head. The cleaning device applies a suction force to the inside of the liquid ejecting head through the nozzles so as to suck the liquid out of the liquid ejecting head for forcible discharging of the liquid. The liquid supplying apparatus includes: a liquid supplying passage through which the liquid is supplied from a liquid supplying source, which is provided at an upstream side, toward the liquid ejecting head, which is provided at a downstream side; a pump that is driven for suction operation and discharging operation, the pump including a pump chamber and a displacement member, the pump chamber being formed as a part of the liquid supplying passage, the displacement member constituting at least a part of the inner surface of the pump chamber, the displacement member being able to become displaced between two or more positions that include a close position for closing an outlet port through which the liquid flows out of the pump chamber to the downstream side, the displacement member becoming displaced in such a way as to increase and decrease capacity of the pump chamber for the suction operation of the pump, which is operation for sucking the liquid into the pump chamber, and the discharging operation of the pump, which is operation for discharging the liquid out of the pump chamber; and a pump driving mechanism that causes the displacement member to become displaced for driving the pump.

With such a configuration, choke cleaning is performed in the following way. In a state in which the displacement member of the pump is positioned at the close position, the cleaning device applies a suction force to the inside of the liquid ejecting head through the nozzles. Thereafter, the pump driving mechanism causes the displacement member that is positioned at the close position to become displaced away from the close position. As a result of the displacement (i.e., change in position) of the displacement member functioning as a choke valve, choke cleaning is performed. After having been displaced away from the close position by the pump driving mechanism, the displacement member does not change its position to return to the close position even when liquid flows from the upstream side of the liquid supplying passage to the downstream side thereof through the outlet port that is now in an open state until it is displaced again by the pump driving mechanism. Therefore, choke cleaning is performed in one burst without repetition of the opening and closing of the outlet port, which causes vibration, by the displacement member functioning as a choke valve. Therefore, it is possible to perform choke cleaning quickly. In addition, the size of an apparatus is made smaller with a reduction in cost.

It is preferable that a liquid supplying apparatus according to the first aspect of the invention should further include: a suction-side one-way valve that is provided at a relatively upstream side of the liquid supplying passage with respect to the pump chamber, the suction-side one-way valve allowing the liquid to pass only in a direction from the upstream side to the downstream side; and a discharging-side one-way valve that is provided at a relatively downstream side of the liquid supplying passage with respect to the pump chamber, the discharging-side one-way valve allowing the liquid to pass only in the direction from the upstream side to the downstream side.

In such a preferred configuration, the pump performs suction operation for sucking liquid into the pump chamber and discharging operation for pumping the liquid out of the pump chamber when the pump driving mechanism causes the displacement member of the pump to become displaced for driving the pump. During the suction operation and the discharging operation, liquid does not flow backward inside the liquid supplying passage. The preferred configuration makes it possible to supply liquid from the liquid supplying source, which is provided at the upstream side, toward the downstream side through the liquid supplying passage with short quick operations.

In the configuration of a liquid supplying apparatus according to the first aspect of the invention, it is preferable that, in a state in which the outlet port is closed by the displacement member and, in addition, the cleaning device is applying a suction force to the inside of the liquid ejecting head through the nozzles so as to suck the liquid out of the liquid ejecting head for forcible discharging of the liquid, the pump driving mechanism should cause the displacement member to become displaced away from the close position, which is triggered by satisfaction of predetermined cleaning conditions.

With such a preferred configuration, it is possible to adopt various conditions as the predetermined cleaning conditions. For example, it may be judged that the predetermined cleaning conditions have been satisfied in a case where time that is required for negative pressure inside the downstream side of the liquid supplying passage with respect to the outlet port to reach a predetermined threshold pressure value, which is sufficiently high, has already elapsed. Or, it may be judged that the predetermined cleaning conditions have been satisfied when it is detected that negative pressure inside the downstream side of the liquid supplying passage with respect to the outlet port has reached such a predetermined sufficiently high threshold pressure value. That is, since cleaning conditions can be selected among various conditions, flexibility in design (i.e., freedom in design) for choke valve control in choke cleaning is enhanced.

In the configuration of a liquid supplying apparatus according to the first aspect of the invention, it is preferable that the pump driving mechanism should cause the displacement member to become displaced away from the close position by putting an actuating fluid chamber, which is separated from the pump chamber by the displacement member that is provided therebetween, into a negative pressure state.

In such a preferred configuration, the actuating fluid chamber, which is separated from the pump chamber by the displacement member that is provided therebetween, is put into a negative pressure state in order to displace the displacement member away from the close position. Therefore, good valve-opening responsiveness of the displacement member, which functions as a choke valve in choke cleaning, is ensured.

It is preferable that a liquid supplying apparatus according to the first aspect of the invention should further include an urging member that urges the displacement member toward the close position.

In such a preferred configuration, the urging force of the urging member is utilized as a force for positioning the displacement member at the close position during choke cleaning and for causing the pump to perform discharging operation after suction operation. Therefore, the pump-driving road of the pump driving mechanism can be reduced.

A liquid ejecting apparatus according to a second aspect of the invention includes: a liquid ejecting head that has a nozzle formation surface and a plurality of nozzles formed through the nozzle formation surface for ejecting liquid through the nozzles; a cleaning device that applies a suction force to the inside of the liquid ejecting head through the nozzles so as to suck the liquid out of the liquid ejecting head for forcible discharging of the liquid; and a liquid supplying apparatus according to the first aspect of the invention.

Having such a configuration, a liquid ejecting apparatus according to the second aspect of the invention offers the same advantages as those of a liquid supplying apparatus according to the first aspect of the invention.

### BRIEF DESCRIPTION OF THE DRAWINGS

The invention will be described with reference to the accompanying drawings, wherein like numbers reference like elements.

FIG. 1 is a diagram that schematically illustrates an example of the configuration of an ink-jet printer according to a first embodiment of the invention.

FIG. 2 is a diagram that schematically illustrates an example of the configuration of an ink-jet printer according to the first embodiment of the invention when a pump is driven for suction operation.

FIG. 3 is a diagram that schematically illustrates an example of the configuration of an ink-jet printer according to the first embodiment of the invention when the pump is driven for discharging operation.

FIG. 4 is a diagram that schematically illustrates an example of the configuration of an ink-jet printer according to the first embodiment of the invention when a choke valve is closed.

FIG. 5 is a diagram that schematically illustrates an example of the configuration of an ink-jet printer according to the first embodiment of the invention when the choke valve is open.

FIG. 6 is a diagram that schematically illustrates an example of the configuration of an ink-jet printer according to a second embodiment of the invention.

FIG. 7 is a diagram that schematically illustrates an example of the configuration of an ink-jet printer according to the second embodiment of the invention when a pump is driven for suction operation.

FIG. 8 is a diagram that schematically illustrates an example of the configuration of an ink-jet printer according to the second embodiment of the invention when the pump is driven for discharging operation.

FIG. 9 is a diagram that schematically illustrates an example of the configuration of an ink-jet printer according to the second embodiment of the invention when a choke valve is closed.

FIG. 10 is a diagram that schematically illustrates an example of the configuration of an ink-jet printer according to the second embodiment of the invention when the choke valve is open.

### DESCRIPTION OF EXEMPLARY EMBODIMENTS

### First Embodiment

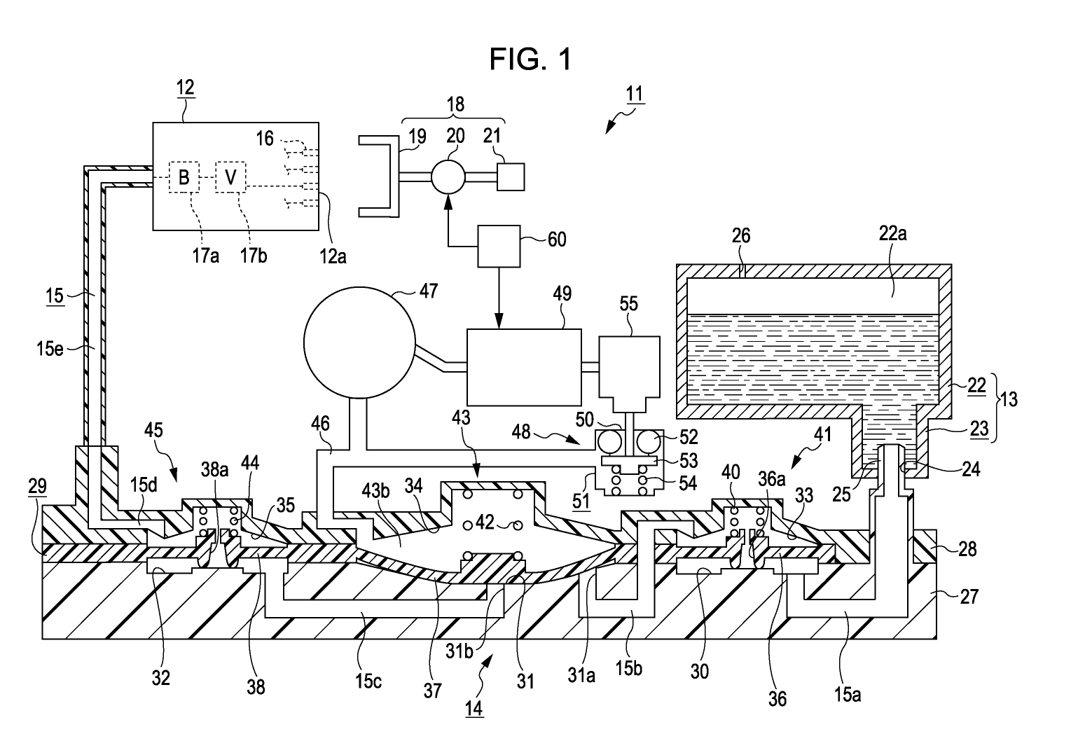

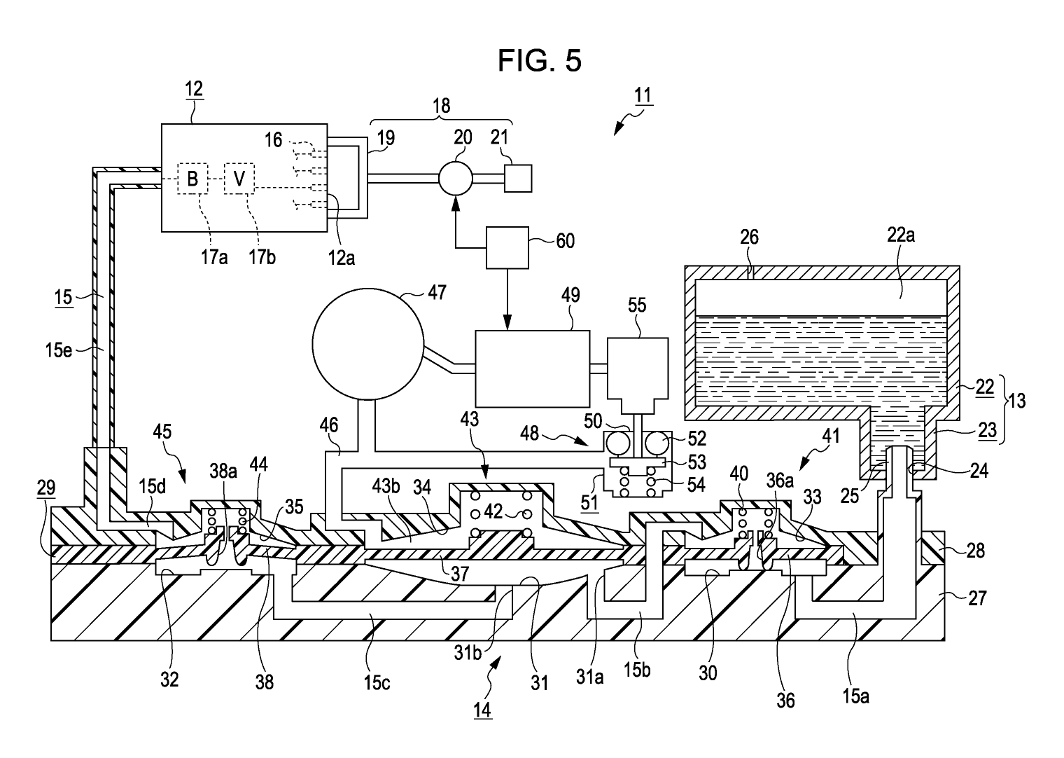

With reference to FIGS. 1 to 5, an ink-jet recording apparatus, which is a kind of a liquid ejecting apparatus according to a first embodiment of the invention, will now be explained in detail. An ink-jet recording apparatus is hereinafter referred to as a printer.

As illustrated in FIG. 1, a printer 11 according to the present embodiment of the invention is provided with a recording head 12, which is an example of a liquid ejecting head, and an ink supplying apparatus 14, which is an example of a liquid supplying apparatus. The recording head 12 ejects ink, which is an example of liquid, onto a target medium. The target medium is not illustrated in the drawing. The ink supplying apparatus 14 supplies ink that is contained in an ink cartridge 13 to the recording head 12. The ink cartridge 13 is an example of a liquid supplying source. An ink flow passage 15 is formed inside the ink supplying apparatus 14. The upstream end of the ink flow passage 15 is connected to the ink cartridge 13. The downstream end of the ink flow passage 15 is connected to the recording head 12. Ink is supplied through the ink flow passage 15 from the ink cartridge 13, that is, from the upstream side, to the recording head 12, that is, to the downstream side. The ink flow passage 15 is an example of a liquid supplying passage.

The printer 11 is provided with a plurality of ink supplying apparatuses 14. The number of the ink supplying apparatuses 14 corresponds to the number of colors (types) of ink used by the printer 11. The structure of the ink supplying apparatus 14 corresponding to each ink color is the same as those of the others. Therefore, a single ink supplying apparatus 14 that corresponds to one ink color only is shown in FIG. 1. Besides the ink supplying apparatus 14, the recording head 12 and the ink cartridge 13 that contains ink of the corresponding one color are shown in FIG. 1. In the following description, the supplying of ink by the single ink supplying apparatus 14 that is shown in FIG. 1 from the upstream ink cartridge 13 to the downstream recording head 12 through the ink flow passage 15 is explained as an example.

As illustrated in FIG. 1, a plurality of nozzles 16 is formed through the nozzle formation surface 12a of the recording head 12. The nozzle formation surface 12a is a surface that faces toward a platen. The platen is not illustrated in the drawing. The number of the nozzles 16 corresponds to the number of the ink supplying apparatuses 14. In the present embodiment of the invention, four nozzles 16 are formed through the nozzle formation surface 12a. Ink that flows through the ink flow passage 15 of the corresponding ink supplying apparatus 14 is supplied to each nozzle 16 through a buffer chamber 17a and a valve unit 17b. Specifically, ink is supplied through the ink flow passage 15 from the upstream ink cartridge 13 to flow into the buffer chamber 17a, which is a chamber that functions as an ink reservoir. Thereafter, the ink flows into the valve unit 17b. Pressure chambers, which are not illustrated in the drawing, are formed inside the valve unit 17b. The pressure chambers temporarily retain ink that has flowed from the buffer chamber 17a into the valve unit 17b. The pressure chambers are in communication with the nozzles 16. When ink is ejected from the nozzle 16, ink whose amount corresponds to the amount consumed in the ejection flows from the buffer chamber 17a into the pressure chamber. A flow adjustment valve, which is not illustrated in the drawing, opens or closes for the controlled flow of ink.

The printer 11 is equipped with a maintenance unit 18. The maintenance unit 18 is provided at a home position, which is a position where the recording head 12 stays when printing is not performed. The maintenance unit 18 is used for cleaning the recording head 12 to unclog the nozzles 16. The maintenance unit 18 is an example of a cleaning device. The maintenance unit 18 includes a cap member 19, a suction pump 20, and a waste ink tank 21. The cap member 19 can be brought into contact with the nozzle formation surface 12a of the recording head 12 so as to enclose the nozzles 16 as a covering cap. The suction pump 20 is driven for sucking ink out of the cap member 19. When the suction pump 20 is driven, ink sucked out of the cap member 19 is drained into the waste ink tank 21. At the time of cleaning, the cap member 19 is moved from the position illustrated in FIG. 1 to be brought into contact with the nozzle formation surface 12a of the recording head 12. Then, the suction pump 20 is driven in this cap contact state to generate negative pressure in the internal space of the cap member 19. As a result, ink that has increased viscosity and/or ink that contains air bubbles is/are discharged out of the recording head 12 toward the waste ink tank 21 due to a suction force.

The ink cartridge 13 includes a case 22 that has a box-like shape. An ink chamber 22a is formed inside the case 22. Ink is contained in the ink chamber 22a of the case 22. A cylinder portion 23 protrudes downward from the bottom of the case 22. The cylinder portion 23 is in communication with the ink chamber 22a. An ink supplying port 24 is formed at the tip of the cylinder portion 23. Ink contained in the ink cartridge 13 can flow out through the ink supplying port 24. When the ink cartridge 13 is attached to the ink supplying apparatus 14, an ink supply needle 25 is inserted into the ink supplying port 24. The ink supply needle 25 protrudes from the ink supplying apparatus 14. The ink supply needle 25 constitutes the upstream end of the ink flow passage 15. An air communication hole 26 is formed through the top wall of the case 22. The ink chamber 22a in which ink is contained is opened to the outside air through the air communication hole 26. Accordingly, atmospheric pressure is applied to the surface of the ink contained in the ink chamber 22a.

Next, the configuration of the ink supplying apparatus 14 is explained in detail below. As illustrated in FIG. 1, the ink supplying apparatus 14 includes a first flow passage formation member 27, a second flow passage formation member 28, and a flexible member 29. The first flow passage formation member 27 is a base member that is made of resin. The second flow passage formation member 28 is also made of resin. The second flow passage formation member 28 is fixed as an upper layer over the first flow passage formation member 27, which is a base lower layer. The flexible member 29 is sandwiched between the first flow passage formation member 27 and the second flow passage formation member 28 when these members 27 and 28 are put together. The material of the flexible member 29 is, for example, a rubber plate. Concave portions 30, 31, and 32 are formed in the upper surface of the first flow passage formation member 27 at a plurality of areas, which are three places in the present embodiment of the invention. Each of the concave portions 30, 31, and 32 has the shape of a circle in a plan view. Specifically, these three concave portions 30, 31, and 32 are arranged in this order as viewed from the right to the left in FIG. 1. The capacity of the right concave portion 30 is smaller than that of the center concave portion 31. The capacity of the right concave portion 30 is substantially the same as that of the left concave portion 32. Accordingly, the capacity of the left concave portion 32 is smaller than that of the center concave portion 31.

On the other hand, concave portions 33, 34, and 35 are formed in the lower surface of the second flow passage formation member 28, which is fixed over the first flow passage formation member 27. The concave portions 33, 34, and 35 are formed at a plurality of areas, which are three places in the present embodiment of the invention. Each of the concave portions 33, 34, and 35 also has the shape of a circle in a plan view. The concave portion 33 is formed opposite to the concave portion 30. The concave portion 34 is formed opposite to the concave portion 31. The concave portion 35 is formed opposite to the concave portion 32. Specifically, these three concave portions 33, 34, and 35 are arranged in this order as viewed from the right to the left in FIG. 1. The capacity of the right concave portion 33 is smaller than that of the center concave portion 34. The capacity of the right concave portion 33 is substantially the same as that of the left concave portion 35. Accordingly, the capacity of the left concave portion 35 is smaller than that of the center concave portion 34.

That is, in the structure of the ink supplying apparatus 14, the concave portions 30, 31, and 32 are formed in the same plane. In addition, the concave portions 33, 34, and 35 are formed in the same plane, which is another plane. Accordingly, it is possible to adopt a layered structure that is made up of a plurality of plate-like members that are laid one over another as the structure of the ink supplying apparatus 14.

The flexible member 29 is sandwiched between the first flow passage formation member 27 and the second flow passage formation member 28 to constitute a partition at a plurality of areas, which are three places in the present embodiment of the invention, more specifically, between the lower concave portions 30, 31, and 32 of the first flow passage formation member 27 and the upper concave portions 33, 34, and 35 of the second flow passage formation member 28, respectively. A portion of the flexible member 29 that is interposed between the concave portion 30 of the first flow passage formation member 27 and the concave portion 33 of the second flow passage formation member 28 functions as a suction-side valve portion (i.e., valve) 36. The suction-side valve portion 36 can become deformed elastically between the concave portion 30 and the concave portion 33 to cause elastic displacement (i.e., change in position caused by elastic deformation).

In like manner, a portion of the flexible member 29 that is interposed between the concave portion 31 of the first flow passage formation member 27 and the concave portion 34 of the second flow passage formation member 28 functions as a diaphragm 37. The diaphragm 37 can become deformed elastically between the concave portion 31 and the concave portion 34 to cause elastic displacement. The diaphragm 37 is an example of a displacement member. In addition, a portion of the flexible member 29 that is interposed between the concave portion 32 of the first flow passage formation member 27 and the concave portion 35 of the second flow passage formation member 28 functions as a discharging-side valve portion 36. The discharging-side valve portion 38 can become deformed elastically between the concave portion 32 and the concave portion 35 to cause elastic displacement.

The area sizes of the deformable portions of the suction-side valve 36, the diaphragm 37, and the discharging-side valve 38 have the following relationships in a plan view. The two-dimensional size of the deformable portion of the diaphragm 37 is larger than that of the deformable portion of the suction-side valve 36. The two-dimensional size of the deformable portion of the suction-side valve 36 is substantially the same as that of the deformable portion of the discharging-side valve 38. Accordingly, the two-dimensional size of the deformable portion of the diaphragm 37 is larger than that of the deformable portion of the discharging-side valve 38.

As illustrated in FIG. 1, the ink supply needle 25, which protrudes through the second flow passage formation member 28, is formed on the upper surface of the first flow passage formation member 27. A first ink flow passage 15a through which the ink supply needle 25 is in communication with the concave portion 30 of the first flow passage formation member 27 is formed inside the first flow passage formation member 27. The ink supply needle 25 and the first ink flow passage 15a constitute a part of the ink flow passage 15 of the ink supplying apparatus 14. A second ink flow passage 15b is formed inside the first flow passage formation member 27 and the second flow passage formation member 28 through the flexible member 29. The concave portion 33 of the second flow passage formation member 28 is in communication with the concave portion 31 of the first flow passage formation member 27 through the second ink flow passage 15b. The second ink flow passage 15b constitutes another part of the ink flow passage 15 of the ink supplying apparatus 14. A third ink flow passage 15c is formed inside the first flow passage formation member 27. The concave portion 31 is in communication with the concave portion 32 through the third ink flow passage 15c. The third ink flow passage 15c constitutes another part of the ink flow passage 15 of the ink supplying apparatus 14.

A fourth ink flow passage 15d is formed inside the second flow passage formation member 28. The concave portion 35 of the second flow passage formation member 28 is in communication with the upper-surface side thereof through the fourth ink flow passage 15d. The fourth ink flow passage 15d constitutes another part of the ink flow passage 15 of the ink supplying apparatus 14. One end of an ink supplying tube 15e (i.e., the upstream end thereof) is connected to the downstream end of the ink flow passage 15d, that is, the open end of the ink flow passage 15d at the upper surface of the second flow passage formation member 28. The ink supplying tube 15e constitutes another part of the ink flow passage 15 of the ink supplying apparatus 14. The other end of the ink supplying tube 15e (i.e., the downstream end thereof) is connected to the buffer chamber 17a, which is formed inside the recording head 12.

As illustrated in FIG. 1, in the structure of the ink supplying apparatus 14, a through hole 36a is formed at the center of the portion of the flexible member 29 that functions as the suction-side valve portion 36. A coil spring 40 is provided inside the upper concave portion 33. The coil spring 40 applies an urging force to the suction-side valve portion 36. Therefore, the suction-side valve portion 36 is urged toward the inner bottom surface of the lower concave portion 30. In the present embodiment of the invention, the concave portions 30 and 33, the suction-side valve portion 36, and the coil spring 40 make up a suction-side one-way valve 41.

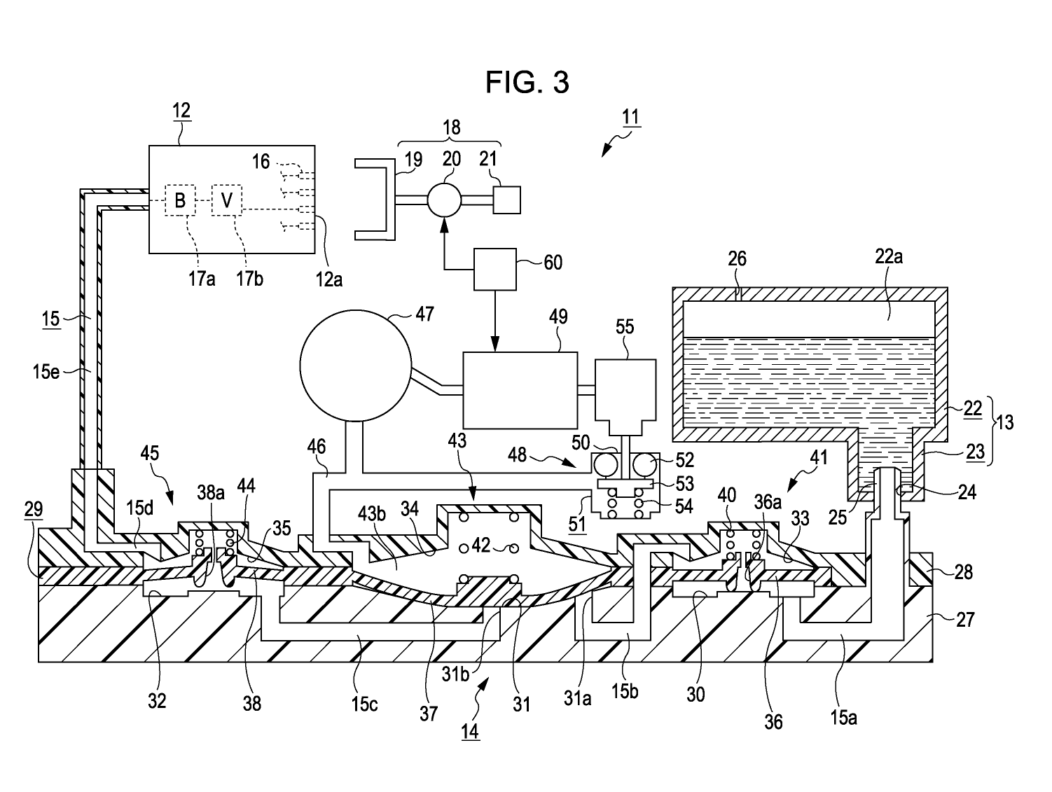

In the structure of the ink supplying apparatus 14, a coil spring 42 is provided inside the upper concave portion 34. The coil spring 42, which is an example of an urging member, applies an urging force to the portion of the flexible member 29 that functions as the diaphragm 37. Therefore, the diaphragm 37 is urged toward the inner bottom surface of the lower concave portion 31. In the present embodiment of the invention, the concave portions 31 and 34, the diaphragm 37, and the coil spring 42 make up a pulsating pump 43. A space that has variable capacity and is surrounded by the diaphragm 37 and the lower concave portion 31 functions as a pump chamber 43a of the pump 43. That is, the diaphragm 37 constitutes a part of the inner wall surface of the pump chamber 43a. The diaphragm 37 can be elastically displaced between two or more positions that include a close position (refer to FIGS. 1 and 3). The close position is a displacement position of the diaphragm 37 for closing an ink inlet port 31a and an ink outlet port 31b. The inlet port 31a is a port through which ink flows into the pump chamber 43a from the upstream second ink flow passage 15b. The outlet port 31b is a port through which ink flows out of the pump chamber 43a to the downstream third ink flow passage 15c.

In like manner, in the structure of the ink supplying apparatus 14, a through hole 38a is formed at the center of the portion of the flexible member 29 that functions as the discharging-side valve portion 38. A coil spring 44 is provided inside the upper concave portion 35. The coil spring 44 applies an urging force to the discharging-side valve portion 38. Therefore, the discharging-side valve portion 38 is urged toward the inner bottom surface of the lower concave portion 32. In the present embodiment of the invention, the concave portions 32 and 35, the discharging-side valve portion 38, and the coil spring 44 make up a discharging-side one-way valve 45.

As illustrated in FIG. 1, a pressure regulation device 47 and an air opening mechanism 48 are connected to the concave portion 34 of the second flow passage formation member 28 through a bifurcated airflow passage 46. The pressure regulation device 47, which adjusts pressure, includes a pressure reduction pump or the like. A control unit 60 controls the driving operation of a driving motor 49. The driving motor 49 is a motor that can turn in the normal direction and in the reverse direction selectively. When the driving motor 49 turns in the normal direction under the control of the control unit 60, the pressure regulation device 47 is driven to generate negative pressure due to driving power, which is transmitted to the pressure regulation device 47 through a one-way clutch. The one-way clutch is not illustrated in the drawing. As a result, the internal pressure of the concave portion 34 of the second flow passage formation member 28, which is connected to the pressure regulation device 47 through the airflow passage 46, also becomes negative. In this respect, a space that has variable capacity and is surrounded by the diaphragm 37 and the concave portion 34 of the second flow passage formation member 28 functions as an actuating fluid chamber 43b, which a chamber whose pressure state changes in accordance with the operation of the pressure regulation device 47. In the present embodiment of the invention, the actuating fluid chamber 43b gets into a negative pressure state.

The control unit 60 is a digital computer that includes a CPU that functions as a central processing unit to execute various arithmetic operations, a ROM that function as a storage device, a RAM, and the like. The CPU, the ROM, and the RAM are not illustrated in the drawing. The control unit 60 controls the driving state of the driving motor 49 when the pump 43 is driven. The control unit 60 controls the suction operation of the suction pump 20 and the driving state of the driving motor 49 for cleaning the recording head 12. In addition, the control unit 60 controls the entire operation of the printer 11 as needed.

The air opening mechanism 48 has the following configuration. An air open valve 53 is provided inside a box 51, which has an air open hole 50. A sealing member 52 is provided inside the box 51 at the air-open-hole (50) side. A coil spring 54, which is also provided inside the box 51, applies an urging force to the air open valve 53. Therefore, the air open valve 53 is constantly urged in a valve-closing direction, which is a direction for sealing the air open hole 50, by the coil spring 54. When the driving motor 49 turns in the reverse direction, driving power is transmitted to a cam mechanism 55 through a one-way clutch that is not illustrated in the drawing, thereby causing the cam mechanism 55 to operate. As a result of the operation of the cam mechanism 55, the air open valve 53 of the air opening mechanism 48 operates in a valve-opening direction against an urging force that is applied thereto by the coil spring 54. That is, the air open valve 53 of the air opening mechanism 48 operates in the valve-opening direction to open the actuating fluid chamber 43b to the outside air from a closed state in which the actuating fluid chamber 43b, which is connected to the air opening mechanism 48 through the airflow passage 46, is in a negative pressure state. As a result of the opening of the actuating fluid chamber 43b to air, the negative pressure state of the actuating fluid chamber 43b is released.

In the present embodiment of the invention, the pressure regulation device 47, the air opening mechanism 48, and the driving motor 49 make up a pump driving mechanism according to an aspect of the invention, which causes the diaphragm 37 to become elastically displaced between two or more positions that include the aforementioned close position in such a way as to increase or decrease the capacity of the pump chamber 43a.

In the illustrated example of FIG. 1, a combination of one pressure regulation device 47, one air opening mechanism 48, and one driving motor 49 for driving the pressure regulation device 47 and the air opening mechanism 48 is provided for each of the plurality of ink supplying apparatuses 14, the number of which corresponds to the number of colors of ink. However, the scope of the invention is not limited to such an exemplary configuration. For example, the illustrated configuration may be modified as follows. The chamber-connection-end side of the airflow passage 46 is branched into a plurality of passages whose number corresponds to the number of the ink supplying apparatuses 14 each of which is provided for the corresponding one of the plurality of ink colors. The chamber connection end of the airflow passage 46 is an end that is in communication with the actuating fluid chamber 43b of the pump 43. The chamber connection end of each of the plurality of branch airflow passages is connected to the actuating fluid chamber 43b of the pump 43 of the corresponding one of the plurality of ink supplying apparatuses 14. With such a modified configuration, it is possible to drive the plurality of ink supplying apparatuses 14 for the respective ink colors by means of a single set of the pressure regulation device 47, the air opening mechanism 48, and the driving motor 49 only. Therefore, the size of the printer 11 can be reduced.

Next, the action of the printer 11, which has the above configuration, is explained below with a focus on the action of the ink supplying apparatus 14 at the time of supplying ink and at the time of choke cleaning. The action of the ink supplying apparatus 14 during ink supply operation is explained first.

As premises for the following explanation, it is assumed that the state shown in FIG. 1 is as follows. FIG. 1 shows a state immediately after the replacement of an old ink cartridge with new one. The suction-side valve portion 36 of the suction-side one-way valve 41 is pressed against the inner bottom surface of the lower concave portion 30 due to an urging force that is applied thereto by the coil spring 40. The diaphragm 37 of the pump 43 is pressed against the inner bottom surface of the lower concave portion 31 due to an urging force that is applied thereto by the coil spring 42. The discharging-side valve portion 38 of the discharging-side one-way valve 45 is pressed against the inner bottom surface of the lower concave portion 32 due to an urging force that is applied thereto by the coil spring 44. The air open valve 53 of the air opening mechanism 48 is set in a closed state to seal the air open hole 50.

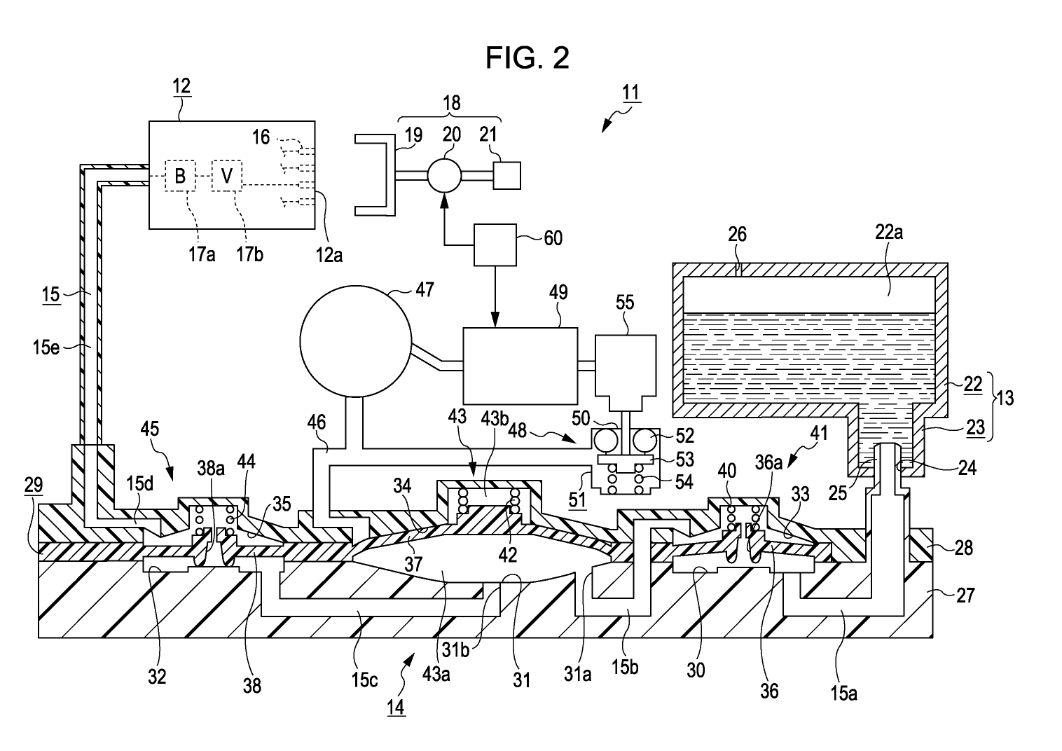

When the ink supplying apparatus 14 supplies ink from the ink cartridge 13 to the recording head 12, as a first step, starting from the state illustrated in FIG. 1, the driving motor 49 turns in the normal direction for driving the pump 43 for suction operation on the basis of a control signal that is sent from the control unit 60. As the driving motor 49 turns in the normal direction, the pressure regulation device 47 generates negative pressure. As a result, the actuating fluid chamber 43b, which is connected to the pressure regulation device 47 through the airflow passage 46, gets into a negative pressure state. Accordingly, the diaphragm 37 of the pump 43 becomes elastically deformed (i.e., displaced) toward the actuating fluid chamber 43b against an urging force that is applied thereto by the coil spring 42, which results in a decrease in the capacity of the actuating fluid chamber 43b (refer to FIG. 2). As the capacity of the actuating fluid chamber 43b decreases, the capacity of the pump chamber 43a of the pump 43, which is formed next to the actuating fluid chamber 43b and is partitioned from the actuating fluid chamber 43b with the diaphragm 37 being formed as a partition between the actuating fluid chamber 43b and the pump chamber 43a, increases.

That is, the pump 43 performs suction operation with the elastic displacement of the diaphragm 37 in a direction for increasing the capacity of the pump chamber 43a. Specifically, the diaphragm 37 changes in position (i.e., is displaced) from the bottom dead point shown in FIG. 1 to the top dead point shown in FIG. 2. The bottom dead point corresponds to the close position for closing the outlet port 31b. At the top dead point, the diaphragm 37 is distanced from the outlet port 31b. As the capacity of the pump chamber 43a increases, the internal pressure of the pump chamber 43a becomes negative. Negative pressure acts on the upper concave portion 33 of the suction-side one-way valve 41 through the second ink flow passage 15b to generate a pressure difference between ink pressure inside the upper concave portion 33 and ink pressure inside the lower concave portion 30. Because of the pressure difference, the suction-side valve portion 36 becomes elastically deformed (i.e., displaced) upward, which is the valve-opening direction, against an urging force that is applied thereto by the coil spring 40. As a result, the first ink flow passage 15a becomes in active communication with the second ink flow passage 15b through the through hole 36a of the suction-side valve portion 36. Therefore, ink flows from the ink cartridge 13 through the first ink flow passage 15a, the concave portion 30, the through hole 36a, the concave portion 33, the second ink flow passage 15b, and the inlet port 31a in the order of appearance herein into the pump chamber 43a due to suction.

On the other hand, when the pump 43 is driven for suction, the negative pressure of the pump chamber 43a acts also on the downstream side of the ink flow passage 15 with respect to the pump chamber 43a (i.e., the flow passage region that is located downstream of the pump chamber 43a) through the outlet port 31b. Specifically, the negative pressure of the pump chamber 43a acts also on the third ink flow passage 15c. However, the lower concave portion 32 of the discharging-side one-way valve 45, with which the downstream side of the third ink flow passage 15c is in communication, is in a valve-closed state in which the discharging-side valve portion 38 is urged in the valve-closing direction by the coil spring 44. This valve-closed state does not transition into a valve-open state unless ink-discharging pressure having a predetermined positive pressure value (e.g., pressure of 13 kPa or greater) is applied to the discharging-side valve portion 38 from the upstream side through the third ink flow passage 15c as a result of the discharging operation of the pump 43. For this reason, with negative pressure acting thereon from the upstream side through the third ink flow passage 15c, the discharging-side valve portion 38 of the discharging-side one-way valve 45 keeps its valve-closed state.

Next, in the state illustrated in FIG. 2, the driving motor 49 turns in the reverse direction for driving the pump 43 for discharging operation on the basis of a control signal that is sent from the control unit 60. As the driving motor 49 turns in the reverse direction, the cam mechanism 55 of the air opening mechanism 48 operates to open the air open valve 53 against an urging force that is applied thereto by the coil spring 54. As the air open valve 53 opens, the actuating fluid chamber 43b that is in a negative pressure state is opened to air. Accordingly, the diaphragm 37 of the pump 43 becomes elastically deformed (i.e., displaced) downward, that is, toward the inner bottom surface of the pump chamber 43a due to an urging force that is applied thereto by the coil spring 42, which results in an increase in the capacity of the actuating fluid chamber 43b (refer to FIG. 3). As the capacity of the actuating fluid chamber 43b increases, the capacity of the pump chamber 43a partitioned from the actuating fluid chamber 43b by the diaphragm 37 decreases.

That is, the pump 43 performs discharging operation with the elastic displacement of the diaphragm 37 in a direction for decreasing the capacity of the pump chamber 43a. Specifically, the diaphragm 37 changes in position from the top dead point to the bottom dead point to pressurize ink that has been sucked into the pump chamber 43a with a predetermined pressure value (e.g., pressure of approximately 30 kPa). Therefore, ink is discharged out of the pump chamber 43a. At the upstream side with respect to the pump chamber 43a, discharging pressure acts on the upper concave portion 33 of the suction-side one-way valve 41 through the inlet port 31a and the second ink flow passage 15b. The discharging pressure acts in combination with the urging force of the coil spring 40 to elastically deform (i.e., displace) the suction-side valve portion 36 downward, which is the valve-closing direction. Since the suction-side valve portion 36 operates in the valve-closing direction, the first ink flow passage 15a and the second ink flow passage 15b get into a non-communication state, that is, a state in which the first ink flow passage 15a is not in active communication with the second ink flow passage 15b. Therefore, ink discharged out of the pump chamber 43a during the discharging operation of the pump 43 does not flow back through the suction-side one-way valve 41 toward the ink cartridge 13.

On the other hand, during the discharging operation of the pump 43, the pressure of ink discharged out of the pump chamber 43a (e.g., pressure of approximately 30 kPa) acts also on the downstream side of the ink flow passage 15 through the third ink flow passage 15c. Therefore, the discharging pressure of the pump 43 acts on the lower concave portion 32 of the discharging-side one-way valve 45 to generate a pressure difference between ink pressure inside the lower concave portion 32 and ink pressure inside the upper concave portion 35. Because of the pressure difference, the discharging-side valve portion 38 becomes elastically deformed (i.e., displaced) upward, which is the valve-opening direction, against an urging force that is applied thereto by the coil spring 44. As a result, the third ink flow passage 15c becomes in active communication with the fourth ink flow passage 15d through the through hole 38a of the discharging-side valve portion 38. Therefore, ink flows from the pump chamber 43a through the outlet port 31b, the third ink flow passage 15c, the concave portion 32, the through hole 38a, the concave portion 35, the fourth ink flow passage 15d, and the ink supplying tube 15e in the order of appearance herein to be supplied to the buffer chamber 17a, which is formed inside the recording head 12, in a pressurized state. The urging force applied by the coil spring 44 of the discharging-side one-way valve 45 is set at a value that allows the discharging-side valve portion 38 to become elastically deformed upward due to the discharge pressure of ink when the ink flows into the lower concave portion 32 of the discharging-side one-way valve 45 during the discharging operation of the pump 43. For example, the urging force of the coil spring 44 is set at approximately 13 kPa.

Thereafter, the discharge pressure of ink that is discharged out of the pump chamber 43a due to pressurization by the diaphragm 37 is maintained in equilibrium throughout each of relatively downstream flow passage regions of the ink flow passage 15 with respect to the upper concave portion 33 of the suction-side one-way valve 41. The downstream flow passage regions that are kept in an equilibrium state include the pump chamber 43a and the lower concave portion 32 of the discharging-side one-way valve 45. Specifically, at the discharging-side one-way valve 45, the position of the discharging-side valve portion 38 is kept at the top dead point. Accordingly, the discharging-side one-way valve 45 is kept in an open state in which the third ink flow passage 15c is in active communication with the fourth ink flow passage 15d through the through hole 38a of the discharging-side valve portion 38.

Thereafter, when the recording head 12 ejects ink onto a target medium (not shown in the drawing), ink whose amount corresponds to the amount of ink consumed in the ejection is supplied from the ink flow passage 15 toward the recording head 12. The ink flows through the buffer chamber 17a and the valve unit 17b of the recording head 12. That is, as ink is consumed at the downstream end (i.e., the recording head 12), ink whose amount corresponds to the amount of consumption is supplied to the recording head 12 provided at the downstream end in a pressurized state due to pressure that is applied by the diaphragm 37 urged in a direction for decreasing the capacity of the pump chamber 43a due to an urging force that is applied thereto by the coil spring 42.

Consequently, the capacity of the pump chamber 43a and the capacity of a space that is surrounded by the lower concave portion 32 and the discharging-side valve portion 38 in the discharging-side one-way valve 45 decrease gradually. Eventually, the position of the diaphragm 37 changes to a position near the bottom dead point, which corresponds to the close position for closing the outlet port 31b. In addition, the position of the discharging-side valve portion 38 changes to a position near the valve-closed position, which is a position for putting the third ink flow passage 15c and the fourth ink flow passage 15d into a non-communication state, that is, a state in which the third ink flow passage 15c is not in active communication with the fourth ink flow passage 15d. Incidentally, in the present embodiment of the invention, the discharge pressure of ink that is discharged out of the pump chamber 43a due to pressurization by the diaphragm 37 at this point in time is approximately 13 kPa.

Then, the driving motor 49 turns in the normal direction again on the basis of a control signal that is sent from the control unit 60. Accordingly, the air open valve 53 moves to the valve-closed position for closing the air open hole 50 at the air opening mechanism 48. In addition, the pressure regulation device 47 generates negative pressure to put the actuating fluid chamber 43b into a negative pressure state. Accordingly, the diaphragm 37 becomes elastically deformed (i.e., displaced) toward the actuating fluid chamber 43b against an urging force that is applied thereto by the coil spring 42. That is, the pump 43 starts suction operation again. As a result, the position of the diaphragm 37 changes to the top dead point to increase the capacity of the pump chamber 43a. Accordingly, the internal pressure of the pump chamber 43a becomes negative. Negative pressure acts to elastically deform (i.e., displace) the suction-side valve portion 36 in the valve-opening direction. As a result, the first ink flow passage 15a becomes in active communication with the second ink flow passage 15b through the through hole 36a of the suction-side valve portion 36. Therefore, ink flows from the ink cartridge 13 into the pump chamber 43a due to suction. Thereafter, the discharging operation of the pump 43 is carried out in the same manner as above. Therefore, ink is supplied from the pump chamber 43a to the recording head 12 in a pressurized state through the downstream ink flow passage.

Next, the action of the ink supplying apparatus 14 during choke cleaning is explained below. In choke cleaning, the diaphragm 37 of the pump 43 is used as a choke valve. In the operation of the printer 11, there is a possibility that air bubbles are formed inside the recording head 12 due to the entering of air through the nozzles 16. In addition, there is a possibility that the clogging of the nozzles 16 occurs because of an increase in the viscosity of ink, or solidification thereof, due to the evaporation of ink solvent through the nozzles 16. In some cases, dust causes the clogging of the nozzles 16. For this reason, the printer 11 according to the present embodiment of the invention carries out so-called choke cleaning to forcibly discharge ink that has increased viscosity and/or ink that contains air bubbles out of the recording head 12 at one burst by means of a suction force. Choke cleaning is performed in the following way.

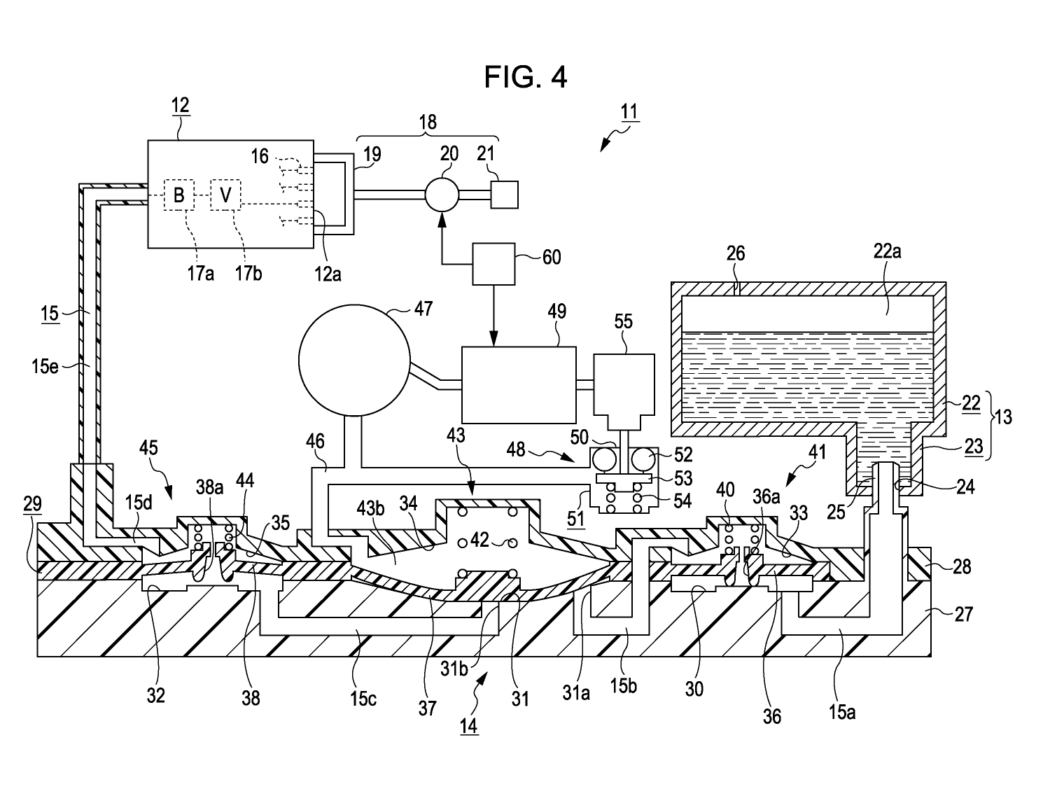

As a first step, as illustrated in FIG. 4, in a state in which the diaphragm 37 of the pump 43 is urged to the bottom dead point (i.e., the close position for closing the outlet port 31b) due to an urging force that is applied thereto by the coil spring 42, the cap member 19 is brought into contact with the nozzle formation surface 12a of the recording head 12 so as to enclose the nozzles 16. In this capped state, the suction pump 20 is driven on the basis of a control signal that is sent from the control unit 60. As a result, the internal space of the cap member 19 that is in contact with the nozzle formation surface 12a of the recording head 12 gets into a negative pressure state. Because of negative pressure, a suction force is applied to the inside of the recording head 12. Even if the discharging-side valve portion 38 of the discharging-side one-way valve 45 was closed before this instant, the negative pressure acts on the upper concave portion 35 of the discharging-side one-way valve 45 through the ink supplying tube 15e and the fourth ink flow passage 15d to open the discharging-side valve portion 38. Therefore, the discharging-side one-way valve 45 opens.

Next, the control unit 60 judges whether predetermined cleaning conditions have been satisfied or not. Specifically, the control unit 60 judges whether time that is required for negative pressure inside the downstream side of the ink flow passage 15 with respect to the outlet port 31b (i.e., the third ink flow passage 15c, the concave portions 32 and 35, the fourth ink flow passage 15d, and the ink supplying tube 15e) to reach a predetermined threshold pressure value, which is sufficiently high, has already elapsed or not on the basis of timer detection. In a case where the control unit 60 judges that the predetermined cleaning conditions have been satisfied, the control unit 60 outputs a control signal for stopping the operation of the suction pump 20. The operation of the suction pump 20 is stopped on the basis of the control signal sent from the control unit 60. Since the suction pump 20 stops its operation, the internal pressure of the recording head 12 and the ink flow passage 15 is kept constant. Thereafter, the control unit 60 outputs, to the driving motor 49, a control signal for changing the position of the diaphragm 37 (i.e., choke valve) that is now being urged to the bottom dead point (i.e., the close position for closing the outlet port 31b) toward the top dead point.

Upon receiving the control signal from the control unit 60, the driving motor 49 turns in the normal direction. Accordingly, the pressure regulation device 47 is driven to generate negative pressure to put the actuating fluid chamber 43b into a negative pressure state. Therefore, the diaphragm 37 becomes elastically deformed toward the actuating fluid chamber 43b against an urging force that is applied thereto by the coil spring 42. That is, the diaphragm 37 becomes displaced away from the bottom dead point (i.e., the close position for closing the outlet port 31b) toward the top dead point. As a result, ink that is retained inside the upstream side of the ink flow passage 15 with respect to the pump chamber 43a is sucked toward the recording head 12 with a great force. Therefore, ink that has increased viscosity and contains air bubbles, which remains inside the recording head 12, is discharged out of the recording head 12 through the nozzles 16 into the cap member 19 at one burst. The ink is drained into the waste ink tank 21.

Next, the control unit 60 judges whether predetermined conditions for ending choke cleaning have been satisfied or not. Specifically, the control unit 60 judges whether time that is preset as the execution time of choke cleaning for forcibly discharging ink out of the recording head 12 has already elapsed or not on the basis of timer detection. In a case where the control unit 60 judges that the predetermined ending conditions have been satisfied, the control unit 60 outputs a control signal for changing the position of the diaphragm 37 functioning as a choke valve to the bottom dead point (i.e., the close position for closing the outlet port 31b) again to the driving motor 49.

Upon receiving the control signal from the control unit 60, the driving motor 49 turns in the reverse direction. As the driving motor 49 turns in the reverse direction, the cam mechanism 55 of the air opening mechanism 48 operates to open the air open valve 53 against an urging force that is applied thereto by the coil spring 54. As the air open valve 53 opens, the actuating fluid chamber 43b that is in a negative pressure state is opened to air. Accordingly, the diaphragm 37 of the pump 43 becomes elastically deformed (i.e., displaced) and thus is put into the bottom dead position (i.e., the close position for closing the outlet port 31b) again due to an urging force that is applied by the coil spring 42, thereby ending choke cleaning.

The present embodiment of the invention offers the following advantages.

(1) In the present embodiment of the invention, when choke cleaning is performed, in a state in which the diaphragm 37 of the pump 43 is positioned at the bottom dead point (i.e., the close position for closing the outlet port 31b), the cap member 19 is brought into contact with the nozzle formation surface 12a of the recording head 12 so as to enclose the nozzles 16. In this capped state, the suction pump 20 is driven. As a result, a suction force is applied to the inside of the recording head 12 through the nozzles 16. Thereafter, the diaphragm 37 is displaced away from the bottom dead point toward the top dead point when it is elastically deformed because of negative pressure generated by the pressure regulation device 47. With the diaphragm 37 functioning as a choke valve, it is possible to perform choke cleaning quickly. After having been displaced away from the bottom dead point toward the top dead point when the actuating fluid chamber 43b gets into a negative pressure state as the driving motor 49 turns in the normal direction, the diaphragm 37 does not change its position to return to the bottom dead point even when ink flows from the upstream side of the ink flow passage 15 to the downstream side thereof through the outlet port 31b that is now in an open state until the negative pressure state of the actuating fluid chamber 43b is released, which occurs when the driving motor 49 turns in the reverse direction. Therefore, choke cleaning is performed in one burst without repetition of the opening and closing of the outlet port 31b, which causes vibration, by the diaphragm 37 functioning as a choke valve. Therefore, it is possible to perform choke cleaning quickly. In addition, the size of an apparatus is made smaller with a reduction in cost.

(2) In the present embodiment of the invention, the diaphragm 37 of the pump 43 is elastically deformed to change its position as driven by the normal rotation of the driving motor 49 and the reverse rotation thereof. The pump 43 performs suction operation for sucking ink into the pump chamber 43a and discharging operation for pumping the ink out of the pump chamber 43a with such displacement of the diaphragm 37. During the suction operation and the discharging operation, ink does not flow backward inside the ink flow passage 15. The present embodiment of the invention makes it possible to supply ink from the ink cartridge 13, which is provided at the upstream end, toward the downstream side through the ink flow passage 15 with short quick operations.

(3) In the present embodiment of the invention, the diaphragm 37 functioning as a choke valve in choke cleaning becomes displaced away from the bottom dead point (i.e., the close position for closing the outlet port 31b) when the control unit 60 judges that time required for negative pressure inside the downstream side of the ink flow passage 15 with respect to the outlet port 31b to reach a predetermined threshold pressure value, which is sufficiently high, has already elapsed on the basis of timer detection. Therefore, the valve-opening timing of the diaphragm 37 functioning as a choke valve is accurate, which makes it possible to perform choke cleaning with high precision. Or, as a modification example, the diaphragm 37 functioning as a choke valve may become displaced away from the bottom dead point (i.e., the close position for closing the outlet port 31b) when it is detected by means of a pressure sensor or the like that negative pressure inside the downstream side of the ink flow passage 15 with respect to the outlet port 31b has reached a predetermined threshold pressure value, which is sufficiently high. That is, since cleaning conditions can be selected among various conditions, flexibility in design (i.e., freedom in design) for choke valve control in choke cleaning is enhanced.

(4) In the present embodiment of the invention, the actuating fluid chamber 43b, which is formed next to the pump chamber 43a and is partitioned from the pump chamber 43a with the diaphragm 37 being formed as a partition between the actuating fluid chamber 43b and the pump chamber 43a, is put into a negative pressure state in order to displace the diaphragm 37 away from the bottom dead point (i.e., the close position for closing the outlet port 31b). Therefore, good valve-opening responsiveness of the diaphragm 37, which functions as a choke valve in choke cleaning, is ensured.

(5) In the present embodiment of the invention, the urging force of the coil spring 42, which is an example of an urging member according to an aspect of the invention, is utilized as a force for positioning the diaphragm 37 at (urging toward) the bottom dead point (i.e., the close position for closing the outlet port 31b) during choke cleaning and for causing the pump 43 to perform discharging operation after suction operation. Therefore, the driving road of the driving motor 49 can be reduced.

### Second Embodiment

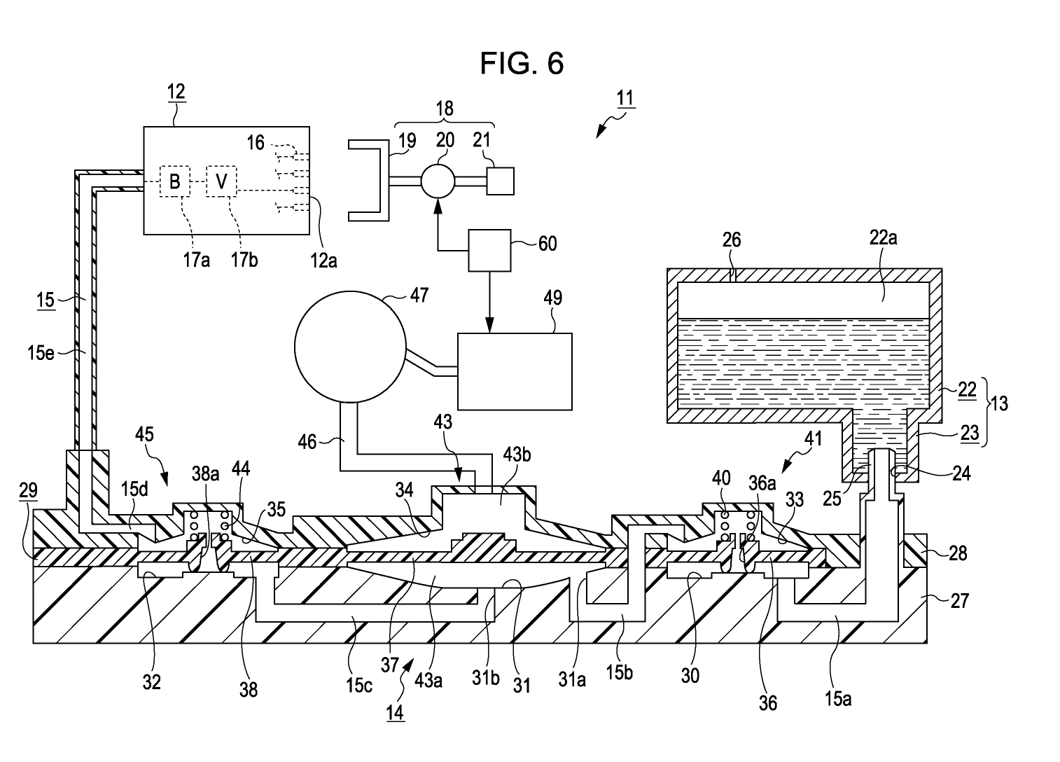

Next, with reference to FIGS. 6 to 10, a second embodiment of the invention is explained below. The configuration of a printer according to the second embodiment of the invention is different from that of a printer according to the first embodiment of the invention in the following points. Firstly, the pump 43 according to the second embodiment of the invention does not include the coil spring 42 for urging the diaphragm 37 toward the bottom dead point. Secondly, a pump driving mechanism according to the second embodiment of the invention does not include the air opening mechanism 48. Thirdly, the pressure regulation device 47 according to the second embodiment of the invention functions not only as a negative pressure generation device but also as a positive pressure generation device. The following description is focused on differences between the first embodiment of the invention and the second embodiment of the invention. Note that the same reference numerals are consistently used for components that are the same as those of a printer according to the first embodiment of the invention or correspond thereto to avoid redundant explanation.

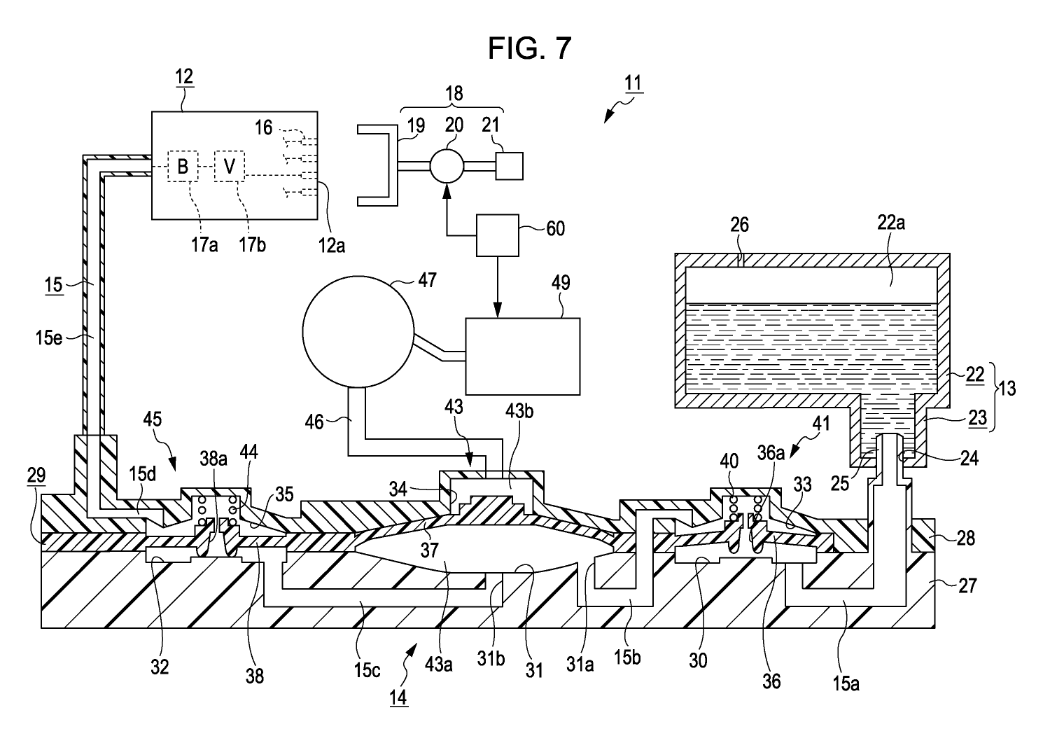

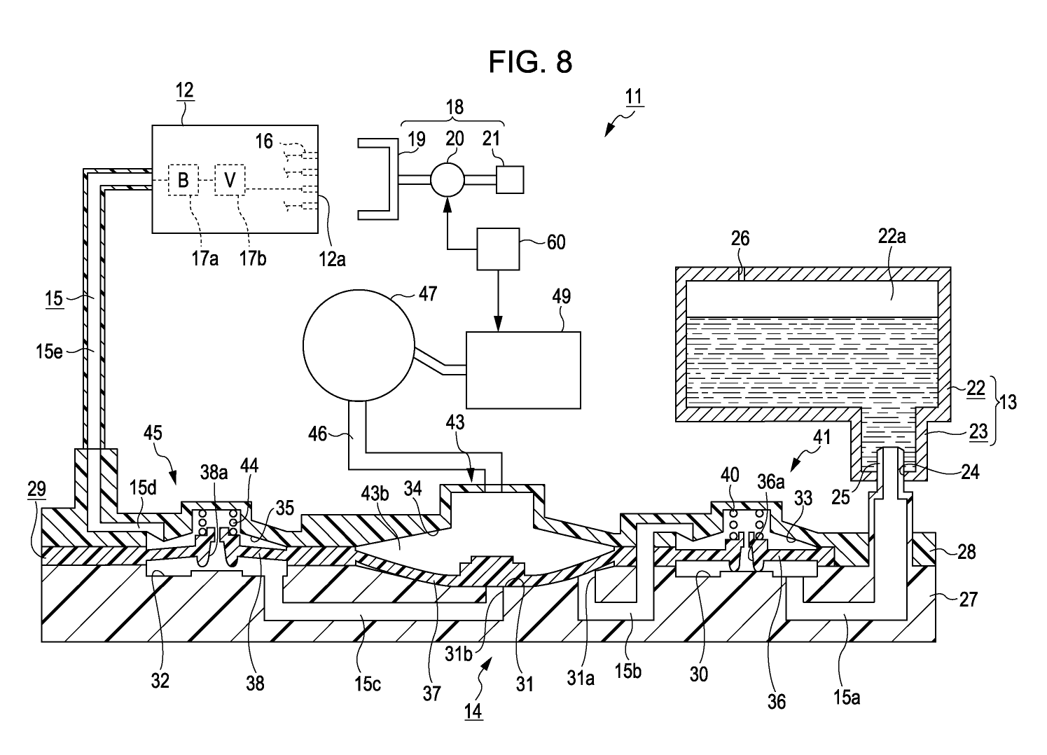

As illustrated in FIG. 6, in the structure of the ink supplying apparatus 14 according to the second embodiment of the invention, there is no coil spring that urges the diaphragm 37 of the pump 43 toward the bottom dead point. Accordingly, in normal non-deformed conditions, the diaphragm 37 is positioned at an intermediate position that is substantially halfway between the bottom dead point (refer to FIG. 8) and the top dead point (refer to FIG. 7). That is, the diaphragm 37 is normally in a level state. In addition, unlike the bifurcated airflow passage 46 according to the first embodiment of the invention, the other end of the airflow passage 46 that has no branch is connected to the concave portion 34 of the second flow passage formation member 28. One end of the airflow passage 46 is connected to the pressure regulation device 47. A space surrounded by the diaphragm 37 and the concave portion 34 functions as the actuating fluid chamber 43b.

In the present embodiment of the invention, when the driving motor 49 turns in the normal direction on the basis of a control signal that is sent from the control unit 60, the pressure regulation device 47 behaves as a negative pressure generation device. Accordingly, the pressure regulation device 47 generates negative pressure to put the actuating fluid chamber 43b into a negative pressure state. Therefore, the diaphragm 37 becomes elastically deformed (i.e., displaced) to reach the top dead point. That is, as illustrated in FIG. 7, with the elastic displacement of the diaphragm 37 to decrease the capacity of the actuating fluid chamber 43b and increase the capacity of the pump chamber 43a, the pump 43 is driven into a suction state. Accordingly, ink is supplied from the ink cartridge 13, that is, from the upstream side, into the pump chamber 43a through the ink flow passage 15.

When the driving motor 49 turns in the reverse direction on the basis of a control signal that is sent from the control unit 60, the pressure regulation device 47 behaves as a positive pressure generation device. Accordingly, the pressure regulation device 47 generates positive pressure to put the actuating fluid chamber 43b into a positive pressure state. Therefore, the diaphragm 37 becomes elastically deformed (i.e., displaced) to reach the bottom dead point. That is, as illustrated in FIG. 8, with the elastic displacement of the diaphragm 37 to increase the capacity of the actuating fluid chamber 43b and decrease the capacity of the pump chamber 43a, the pump 43 is driven into a discharging state. Accordingly, ink is supplied from the pump chamber 43a to the recording head 12, that is, to the downstream side, through the ink flow passage 15.

Thereafter, the normal rotation of the driving motor 49 and the reverse rotation thereof are repeated on the basis of a control signal that is sent from the control unit 60. Therefore, the suction operation of the pump 43 and the discharging operation thereof are repeated. As a result, ink is supplied from the ink cartridge 13 provided at the upstream end to the recording head 12 provided at the downstream end through the ink flow passage 15 with short quick operations.

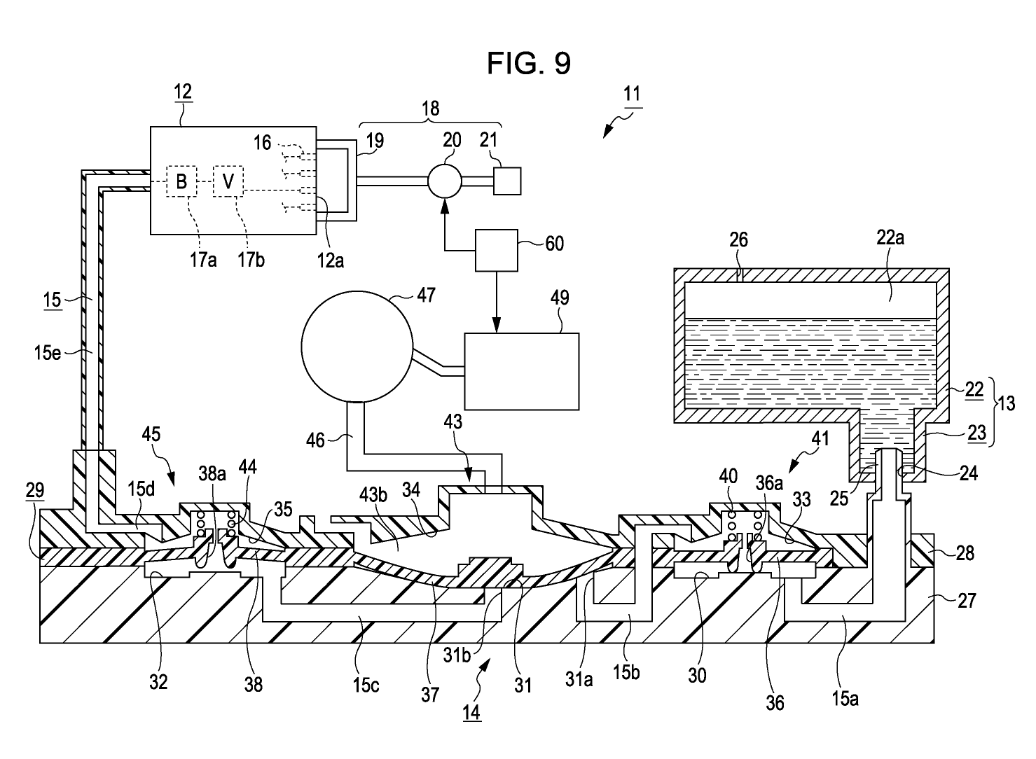

In the present embodiment of the invention, choke cleaning is performed in the following way. As a first step, the driving motor 49 turns in the reverse direction on the basis of a control signal that is sent from the control unit 60. The actuating fluid chamber 43b is put into a positive pressure state. Therefore, as illustrated in FIG. 9, the diaphragm 37 becomes elastically deformed (i.e., displaced) to reach the bottom dead point (i.e., the close position for closing the outlet port 31b). Next, in a state in which the diaphragm 37 is positioned at the bottom dead point, the cap member 19 is brought into contact with the nozzle formation surface 12a of the recording head 12 so as to enclose the nozzles 16. In this capped state, the suction pump 20 is driven on the basis of a control signal that is sent from the control unit 60. As a result, the internal space of the cap member 19 that is in contact with the nozzle formation surface 12a of the recording head 12 gets into a negative pressure state. Because of negative pressure, a suction force is applied to the inside of the recording head 12.

Next, the control unit 60 judges whether predetermined cleaning conditions have been satisfied or not in the same manner as done in the first embodiment of the invention. Specifically, the control unit 60 judges whether time that is required for negative pressure inside the downstream side of the ink flow passage 15 with respect to the outlet port 31b to reach a predetermined threshold pressure value, which is sufficiently high, has already elapsed or not on the basis of timer detection. In a case where the control unit 60 judges that the predetermined cleaning conditions have been satisfied, the control unit 60 outputs a control signal for stopping the operation of the suction pump 20. The operation of the suction pump 20 is stopped on the basis of the control signal sent from the control unit 60. Since the suction pump 20 stops its operation, the internal pressure of the recording head 12 and the ink flow passage 15 is kept constant. Thereafter, the control unit 60 outputs, to the driving motor 49, a control signal for changing the position of the diaphragm 37 (i.e., choke valve) that is now being pressed to the bottom dead point (i.e., the close position for closing the outlet port 31b) toward the top dead point.

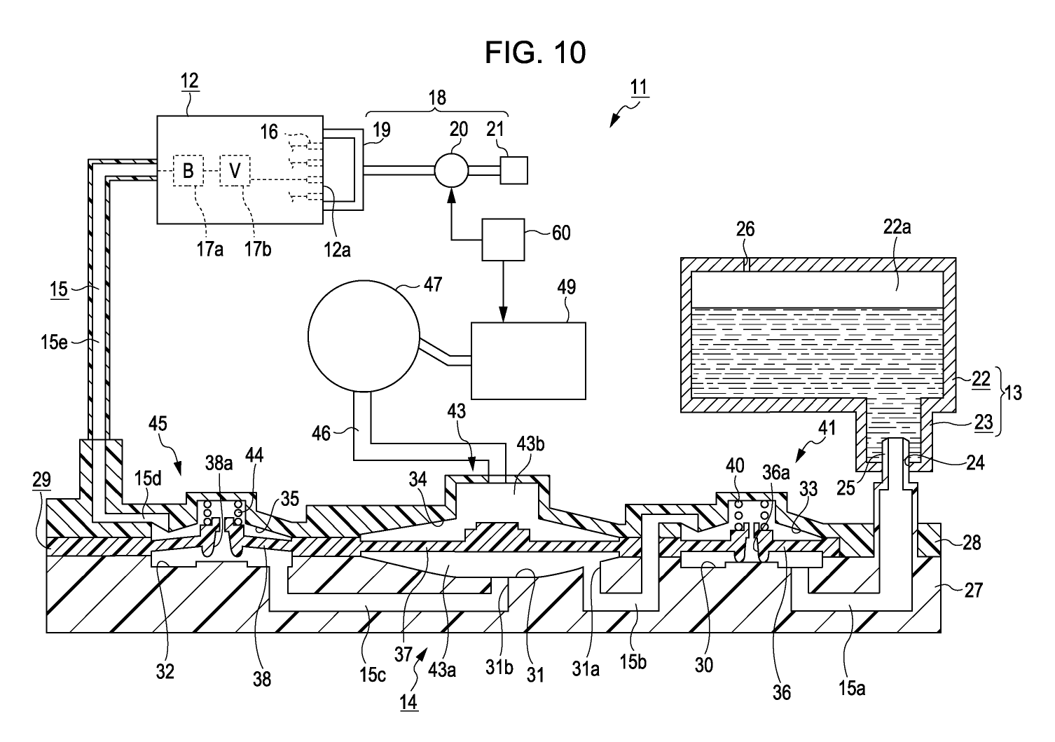

Upon receiving the control signal from the control unit 60, the driving motor 49 turns in the normal direction. Accordingly, the pressure regulation device 47 is driven to generate negative pressure to put the actuating fluid chamber 43b into a negative pressure state. Therefore, as illustrated in FIG. 10, the diaphragm 37 becomes elastically deformed toward the actuating fluid chamber 43b. That is, the diaphragm 37 becomes displaced away from the bottom dead point (i.e., the close position for closing the outlet port 31b) toward the top dead point. As a result, ink that is retained inside the upstream side of the ink flow passage 15 with respect to the pump chamber 43a is sucked toward the recording head 12 with a great force. Therefore, ink that has increased viscosity and contains air bubbles, which remains inside the recording head 12, is discharged out of the recording head 12 through the nozzles 16 into the cap member 19 at one burst. The ink is drained into the waste ink tank 21.

Thereafter, the control unit 60 judges whether predetermined conditions for ending choke cleaning have been satisfied or not in the same manner as done in the first embodiment of the invention. Specifically, the control unit 60 judges whether time that is preset as the execution time of choke cleaning for forcibly discharging ink out of the recording head 12 has already elapsed or not on the basis of timer detection. In a case where the control unit 60 judges that the predetermined ending conditions have been satisfied, the control unit 60 outputs a control signal for stopping the operation of the driving motor 49. The operation of the driving motor 49 is stopped on the basis of the control signal sent from the control unit 60. Therefore, the negative pressure state of the actuating fluid chamber 43b is released. As a result, the diaphragm 37 is put into at an intermediate position that is substantially halfway between the bottom dead point and the top dead point, thereby ending choke cleaning.

In addition to the advantageous effects (1) to (4) of the first embodiment of the invention, the second embodiment of the invention offers the following advantages.

(6) In the present embodiment of the invention, when the diaphragm 37 functioning as a choke valve becomes displaced away from the bottom dead point toward the top dead point, there is not any urging force of a coil spring that acts against the upward displacement. For this reason, the valve-opening responsiveness of the diaphragm 37, which functions as a choke valve in choke cleaning, is further enhanced.

(7) In the present embodiment of the invention, the pump 43 of the ink supplying apparatus 14 is not provided with the coil spring 42. Therefore, it is possible to reduce the number of members.

The foregoing exemplary embodiments of the invention may be modified as follows.

In the first embodiment of the invention, the pressure regulation device 47 may function not as a negative pressure generation device but as a positive pressure generation device when the driving motor 49 turns in the normal direction. In such a modified configuration, the coil spring 42, which is a compression spring, is provided not in the actuating fluid chamber 43b but in the pump chamber 43a. Or, in such a modified configuration, an extension spring is used for the coil spring 42 as a substitute for a compression spring; and in addition, the extension coil spring 42 is provided in the actuating fluid chamber 43b. That is, in these modification examples, the diaphragm 37 is elastically displaced by means of the urging force of a spring in such a way as to increase the capacity of the pump chamber 43a when the pump 43 is driven for suction operation, whereas the pressure regulation device 47 functioning as a positive pressure generation device blows pressurized air into the upper concave portion 34 of the pump 43 (into the actuating fluid chamber 43b according to an exemplary embodiment of the invention) when the pump 43 is driven for discharging operation.

In the foregoing embodiments of the invention, it is explained that the diaphragm 37, which is a portion of the flexible member 29, becomes elastically displaced in such a way as to increase or decrease the capacity of the pump chamber 43a of the pump 43. However, the scope of the invention is not limited to such an exemplary configuration. For example, a piston that separates the pump chamber 43a and the actuating fluid chamber 43b from each other and has good rigidity may be used as a displacement member according to an aspect of the invention for increasing or decreasing the capacity of the pump chamber 43a.

In the first embodiment of the invention, an urging member is not limited to the coil spring 42. For example, a leaf spring (i.e., flat spring), a rubber member, or the like may be used as an urging member.

In the foregoing embodiments of the invention, air is taken as an example of an actuating fluid for operating the pump 43. Liquid such as silicon oil may be used as an actuating fluid.

The ink-jet printer 11 is taken as an example of a liquid ejecting apparatus in the foregoing description of exemplary embodiments of the invention. However, the scope of the invention is not limited to an ink-jet printer. The invention can be applied to various liquid ejecting apparatuses that eject or discharge various kinds of liquid that include ink but not limited thereto. It can be applied to various micro-drop liquid ejecting apparatuses that are provided with micro-drop liquid ejecting heads for discharging liquid drops whose amount is very small. Herein, a “liquid drop” is a form or a state of liquid in the process of ejection of the liquid from a liquid ejecting apparatus. The liquid drop encompasses, for example, a particulate drop, a tear-shaped drop, and a viscous/thready drop that forms a thread tail, without any limitation thereto. The “liquid” may be made of any material as long as a liquid ejecting apparatus can eject it. The liquid may be any substance as long as it is in a liquid phase. It may have high viscosity or low viscosity. It may be sol or gel water. Or, it may be fluid that includes, without any limitation thereto, inorganic solvent, organic solvent, solution, liquid resin, and liquid metal (e.g., metal melt). The “liquid” is not limited to liquid as a state of a substance. It encompasses a liquid/liquefied matter/material that is made as a result of dissolution, dispersion, or mixture of particles of a functional material made of a solid such as pigment, metal particles, or the like into/with a solvent, though not limited thereto. Besides ink explained in the foregoing exemplary embodiments, liquid crystal is a typical example of the liquid. The term “ink” encompasses various types of ink having various liquid compositions such as popular water-based ink, oil-based ink, gel ink, hot melt ink, or the like. Examples of various liquid ejecting apparatuses are: an apparatus that ejects liquid in which, for example, a material such as an electrode material, a color material, or the like that is used in the production of a liquid crystal display device, an organic EL (electroluminescence) display device, a surface/plane emission display device, a color filter, or the like is dispersed or dissolved, an apparatus that ejects a living organic material that is used for production of biochips, an apparatus that is used as a high precision pipette and ejects liquid as a sample, a textile printing apparatus, a micro dispenser, and the like. In addition, the invention is applicable to and can be embodied as a liquid ejecting apparatus that ejects, with high precision, lubricating oil onto a precision instrument and equipment including but not limited to a watch and a camera. Moreover, the invention is applicable to and can be embodied as a liquid ejecting apparatus that ejects liquid of a transparent resin such as an ultraviolet ray curing resin or the like onto a substrate so as to form a micro hemispherical lens (optical lens) that is used in an optical communication element or the like. Furthermore, the invention is applicable to and can be embodied as a liquid ejecting apparatus that ejects an etchant such as acid or alkali that is used for the etching of a substrate or the like. The scope of the application of the invention is not limited to those enumerated or explained above. The invention can be applied to various liquid ejecting apparatuses that eject or discharge various kinds of liquid.

What is claimed is:

1. A liquid supplying apparatus that is provided in a liquid ejecting apparatus, the liquid ejecting apparatus including a liquid ejecting head and a cleaning device, the liquid ejecting head having a nozzle formation surface and a plurality of nozzles formed through the nozzle formation surface, the liquid ejecting apparatus ejecting liquid through the nozzles of the liquid ejecting head, the cleaning device applying a suction force to the inside of the liquid ejecting head through the nozzles so as to suck the liquid out of the liquid ejecting head for forcible discharging of the liquid, the liquid supplying apparatus comprising:
a liquid supplying passage through which the liquid is supplied from a liquid supplying source, which is provided at an upstream side, toward the liquid ejecting head, which is provided at a downstream side;
a pump that is driven for suction operation and discharging operation, the pump including a pump chamber and a displacement member, the pump chamber being formed as a part of the liquid supplying passage, the displacement member constituting at least a part of the inner surface of the pump chamber, the displacement member being able to become displaced between two or more positions that include a close position for closing an outlet port through which the liquid flows out of the pump chamber to the downstream side, the displacement member becoming displaced in such a way as to increase and decrease capacity of the pump chamber for the suction operation of the pump, which is operation for sucking the liquid into the pump chamber, and the discharging operation of the pump, which is operation for discharging the liquid out of the pump chamber; and
a pump driving mechanism that causes the displacement member to become displaced for driving the pump.

2. The liquid supplying apparatus according to claim 1, further comprising:
a suction-side one-way valve that is provided at a relatively upstream side of the liquid supplying passage with respect to the pump chamber, the suction-side one-way valve allowing the liquid to pass only in a direction from the upstream side to the downstream side; and
a discharging-side one-way valve that is provided at a relatively downstream side of the liquid supplying passage with respect to the pump chamber, the discharging-side one-way valve allowing the liquid to pass only in the direction from the upstream side to the downstream side.

3. The liquid supplying apparatus according to claim 1, wherein, in a state in which the outlet port is closed by the displacement member and, in addition, the cleaning device is applying a suction force to the inside of the liquid ejecting head through the nozzles so as to suck the liquid out of the liquid ejecting head for forcible discharging of the liquid, the pump driving mechanism causes the displacement member to become displaced away from the close position, which is triggered by satisfaction of predetermined cleaning conditions.

4. The liquid supplying apparatus according to claim 1, wherein the pump driving mechanism causes the displacement member to become displaced away from the close position by putting an actuating fluid chamber, which is separated from the pump chamber by the displacement member that is provided therebetween, into a negative pressure state.

5. The liquid supplying apparatus according to claim 1, further comprising an urging member that urges the displacement member toward the close position.

6. A liquid ejecting apparatus comprising:
a liquid ejecting head that has a nozzle formation surface and a plurality of nozzles formed through the nozzle formation surface for ejecting liquid through the nozzles;
a cleaning device that applies a suction force to the inside of the liquid ejecting head through the nozzles so as to suck the liquid out of the liquid ejecting head for forcible discharging of the liquid; and
the liquid supplying apparatus according to claim 1.
